(19) United States
(12) Patent Application Publication
(10) Pub. No.: US 2016/0104399 A1
(43) Pub. Date: Apr. 14, 2016

(54) Decorative Tree Cover

(71) Applicant: Steven Gottschalk, Garland, TX (US)

(72) Inventor: Steven Gottschalk, Garland, TX (US)

(21) Appl. No.: 14/849,850

(22) Filed: Sep. 10, 2015

Related U.S. Application Data
(60) Provisional application No. 62/063,002, filed on Oct. 13, 2014.

(51) Int. Cl. G09F 23/00; G09F 15/00

(52) U.S. Cl. CPC G09F 23/00; G09F 15/0037; G09F 15/0018

(57) ABSTRACT

A decorative tree cover for displaying an image on a portion of a tree trunk is provided. The device includes a plurality of adjacently spaced vertical panels including a drawstring adapted to connect each panel. An upper belt and a lower belt are disposed on opposing ends of the vertical panels, wherein the upper belt and the lower belt include adjustable buckles thereon. The upper belt and lower belt are configured to removably attach the vertical panels around a tree trunk. The device enables a user to display an image on a tree trunk via the vertical panels.

### CROSS REFERENCE TO RELATED APPLICATION

This application claims the benefit of U.S. Provisional Application No. 62/063,002 filed on Oct. 13, 2014. The above identified patent application is herein incorporated by reference in its entirety to provide continuity of disclosure.

### BACKGROUND OF THE INVENTION

### Field of the Invention

The present invention relates to a decorative panel for a tree trunk. More specifically, the present invention relates to a device for displaying an image on a portion of a tree trunk including a plurality of adjacently spaced vertical panels with an image thereon. The vertical panels include an upper belt and a lower belt, wherein the upper and lower belts are disposed on opposing ends of the vertical panels. The belts are configured to removably attach the vertical panels around a tree trunk.

Many, if not most, homeowners, tree growers, and park administrators plant young trees around their property. The current practice to protect the bark of young trees against both damage by animals and damage during general maintenance of the premises, involves using a solid piece of tubular plastic material, such as PVC pipe or a rubber hose, to encircle the lower portion of the tree trunk. After the tree becomes sufficiently large and strong, the tubular material is cut away. However, these tubular plastic materials provide no aesthetic value and generally have an unfavorable appearance.

Additionally, there are many ways to decorate for the holidays, and people are always looking for new and original ways to celebrate special occasions. These include lawn ornaments, exterior decorations for the home, and other outdoor assemblies that signify a given holiday or event. For those with trees on their property, the tree provides a steady, reliable support to hang or attach adornments thereto. While balloons can fly away or deflate, and handmade signs fall apart in the sun and rain, the present invention contemplates a new sign and decoration that is configured to attach to a tree trunk. The present invention may be used as decoration or may alternatively be used as a means for displaying advertising material.

### SUMMARY OF THE INVENTION

In view of the foregoing disadvantages inherent in the known types of tree covers now present in the prior art, the present invention provides a decorative tree cover wherein the same can be utilized for providing convenience for the user when displaying an image on a tree trunk.

It is therefore an object of the present invention to provide a decorative cover for tree trunks that displays an image thereon. The decorative cover includes a plurality of adjacently spaced vertical panels. The vertical panels include an upper belt and a lower belt disposed on opposing ends of the vertical panels, wherein the upper belt and the lower belt include adjustable buckles thereon. The upper belt and lower belt are configured to removably attach the vertical panels around a tree trunk.

It is another object of the present invention to provide a decorative cover for tree trunks including adjacently spaced vertical panels having a first aperture and a second aperture on opposing ends of the vertical panels. The first and second apertures are adapted to receive a drawstring so as to attach the panels to one another.

It is yet another object of the present invention to provide a decorative cover for tree trunks including an upper belt and a lower belt assembly located on opposing ends of the vertical panels. The upper belt and the lower belt include adjustable buckles on distal ends of the belt. One end includes a tab configured to receive a clasp on the opposing end. The upper belt and lower belt are configured to removably attach the vertical panels around a tree trunk.

Still yet another object of the present invention is to provide a decorative cover for tree trunks wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the decorative tree cover according to one embodiment of the present invention.

FIG. 2 shows a cross sectional view of the decorative tree cover according to one embodiment of the present invention.

FIG. 3 shows the decorative tree cover attached to a tree trunk according to one embodiment of the present invention.

FIG. 4 shows the decorative tree cover attached to a tree trunk according to another embodiment of the present invention.

### DETAILED DESCRIPTION OF THE INVENTION

Reference is made herein to the attached drawings. Like reference numerals are used throughout the drawings to depict like or similar elements of the decorative tree cover. For the purposes of presenting a brief and clear description of the present invention, the preferred embodiment will be discussed as used for displaying an image on a tree trunk. The figures are intended for representative purposes only and should not be considered to be limiting in any respect.

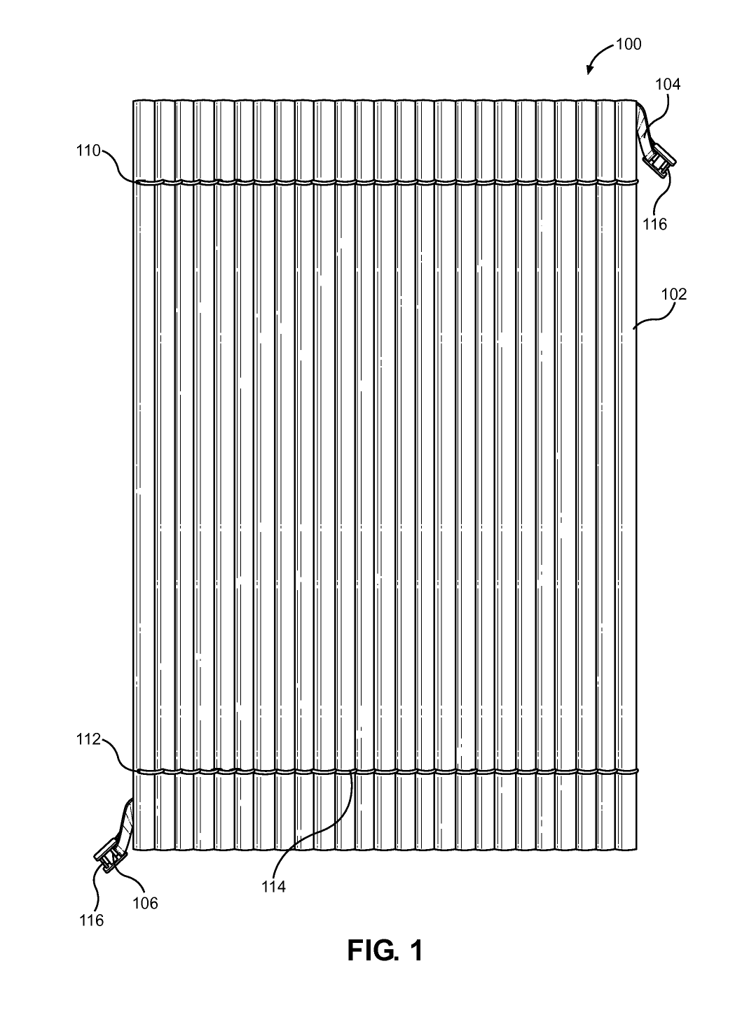

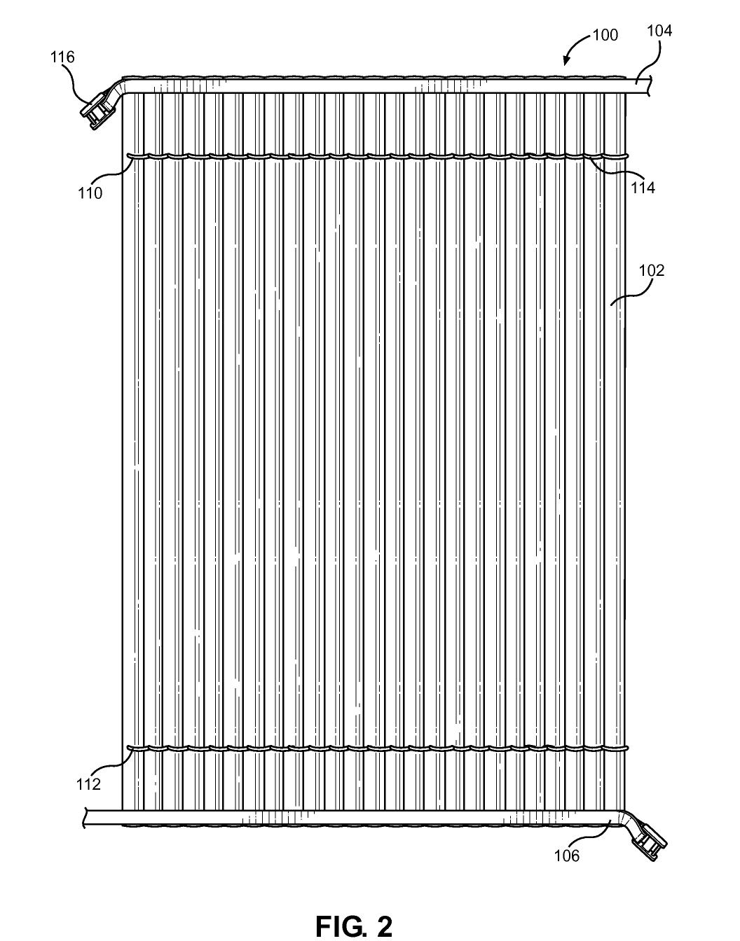

Referring now to FIGS. 1 and 2, there are shown perspective views of the decorative tree cover according to one embodiment of the present invention. The decorative tree cover 100 comprises an assembly having a plurality of vertically aligned panels 102 that form a substantially uniform surface. The exterior surface is configured to be adorned or marked with desired indicia or decorations, while the upper and lower edge of the assembly support an upper and lower belt strap assembly 104, 106. Each tree belt strap assembly 104, 106 comprises an elongated strap that secures the corresponding portion of the panels 102 to the tree by encircling the tree and securing together around the backside of the tree. In this way, the decorative tree cover 100 is secured to a tree trunk using the belt strap assemblies 104, 106.

The vertical panels 102 are elongated panels that have a first end and a second end. The vertical panels 102 are positioned adjacent to one another in a side-by-side fashion so as to form a unitary surface that is adorned with desired indicia or decorations. The vertical panels 102 include a first aperture 110 and a second aperture 112 on the first end and the second end of the panels 102. A drawstring 114 removably connects each of the vertical panels 102 by placing the drawstring 114 through the first and second apertures 110, 112 of each panel 102. The drawstring 114 can be tightened or loosened to provide different spacing between each of the panels 102. The use of a plurality of panels 102 allows the decorative tree cover 100 to bend or flex around the exterior surface of a tree. In this way, the decorative tree cover 100 is able to be used on trees of various shapes and sizes, as well as on other support surfaces, such as poles, posts, columns, and the like.

The upper and lower belt strap assemblies 104, 106 comprises an elongated strap that secures the corresponding portion of the panels to the tree by encircling the tree and securing together around the backside of the tree. The upper and lower belt strap assemblies 104, 106 are located on a rear surface of the panels 102 and are affixed to the panels 102 via a fastener such as adhesives, hook and loop fasteners, or latches. A buckle 116 is located along one end of each strap and is used to secure one end of each strap to the opposite end. The belt strap assemblies 104, 106 comprises a spring buckle that supports the free end of the strap therein and clamps the strap to the buckle. Each strap is secured to its opposite buckle and can be drawn therethrough and supported in a tensioned configuration.

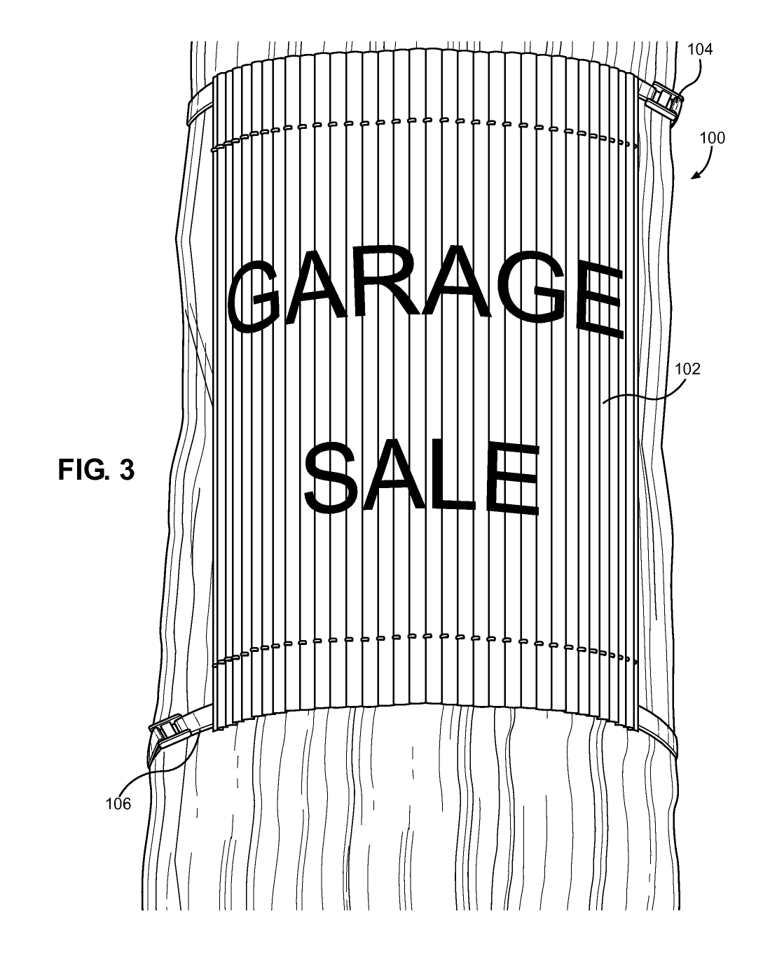

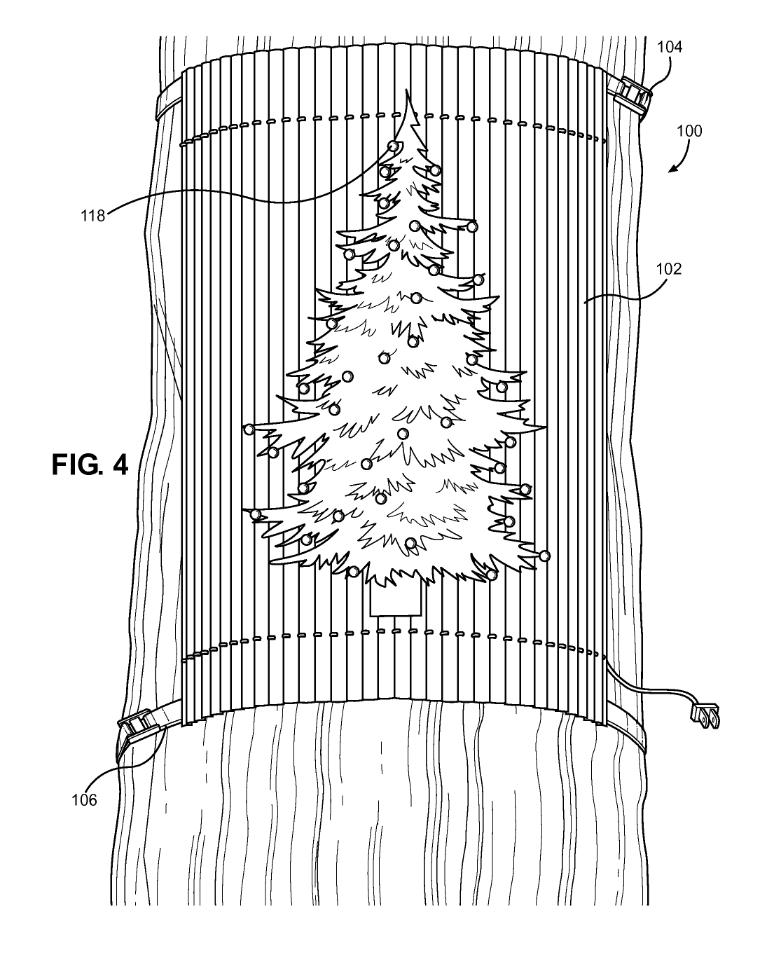

Referring now to FIGS. 3 and 4, there are shown decorative tree covers attached to a tree trunk according to one embodiment of the present invention. The decorative tree cover 100 comprises vertically oriented and adjacently disposed panels 102 that provide a way for people decorate or mark their property. The panels 102 are individual slats that are connected to one another as closely together as possible to form a substantially uniform surface upon which indicia, adornments, or decoration may be applied.

Each panel 102 can support coloration or decoration with a desired design or indicia to celebrate a particular holiday or provide a desired message. Examples include holidays, birthday or newborn celebratory messages, and advertising messages. In some embodiments, the decorative tree cover 100 may include an array of light sources, such as LEDs 118 to further adorn the panels 102. In use, an image, decoration, indicia, or other such display is imprinted or attached to the exterior surface of the panels 102. The upper and lower belt strap assemblies 104, 106 of the decorative tree cover 102 are connected at the upper and lower edges around the trunk of the tree and fastened together using a buckle or similar strap fastener so that the assembly may easily remain in place along the tree trunk. In this way, an image or other decorative pattern can be displayed on a tree trunk.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device for covering a portion of a tree trunk, comprising:
a plurality of adjacently spaced vertical panels;
an upper belt assembly and a lower belt assembly disposed on opposing ends of the plurality of vertical panels, wherein the upper belt assembly and the lower belt assembly include adjustable buckles thereon;
wherein the upper belt assembly and lower belt assembly are configured to removably attach the vertical panels around a tree trunk.

2. The device of claim 1, wherein the vertical panels include at least one image thereon.

3. The device of claim 1, wherein the vertical panels include a first aperture and a second aperture located on opposing ends of the vertical panels.

4. The device of claim 3, wherein the first aperture and the second aperture are configured to receive a drawstring therethrough so as to attach each of said plurality of vertical panels.

5. The device of claim 1, wherein the adjustable buckle includes a first end and second end that are configured to surround the tree trunk.

6. The device of claim 5, wherein the first end includes a tab and the second end includes a buckle such that the tab receives the buckle therein.
